(19) United States
(12) Patent Application Publication
(10) Pub. No.: US 2006/0227424 A1
(43) Pub. Date: Oct. 12, 2006

(54) Light tunnel module

(75) Inventors: Jen-Chih Wang, Taoyuan Hsien (TW); Ching-Hsiang Yu, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC., Taoyuan Hsien (TW)

(21) Appl. No.: 11/212,731

(22) Filed: Aug. 29, 2005

(30) Foreign Application Priority Data
Apr. 8, 2005 (TW) 094111129

(51) Int. Cl. G02B 5/126

(52) U.S. Cl. 359/535

(57) ABSTRACT

A light tunnel device. The light tunnel device includes a plurality of reflectors and at least one sleeve. The sleeve completely or partially covers the reflectors. The reflectors are piled together to form a hollow tunnel, allowing a light to pass therethrough. The profile of the reflectors is trapezoid, rectangular or polygonal.

### BACKGROUND

The invention relates to a light tunnel module in particular to a light tunnel module that is stable, not deformed under high temperature and capable of being used in various projection systems.

A conventional projection system often comprises a condenser receiving and uniformly distributing incident light. The uniformly distributed light is then output from the condenser.

The conventional projection system may be a CRT, an LCD, a DLP, or a micro-display. Referring to FIG. 1, Taiwan Patent No. 517855 discloses a conventional DLP 10 comprising a light source 1, a reflector 2, a color wheel 4, a condenser 3, a lens assembly 5, a digital micro-mirror device (DMD) 6 and a lens 7. The condenser 3 is a hollow pipe. Specifically, the condenser 3 is a light tunnel receiving and outputting light.

A light from the light source 1 is transmitted through the reflection of the reflector 2 and to the color wheel 4 directly. The light passes through the color wheel 4 with three primary colors and is thereby divided into coaxial red, green and blue lights. The coaxial red, green and blue lights are uniformly distributed by the condenser 3 and then imaged on the DMD 6 via the lens assembly 5. The DMD 6 converts continuous lights to gray level and displays the color thereof with the red, green, and blue colors. The light is then imaged via the lens 7.

A conventional condenser often comprises multiple glass plates with inner walls coated with optical films. The glass plates are stacked, forming a light tunnel. A light can enter the light tunnel and be reflected thereby. The outer surfaces of the glass plates are directly held by jigs. The condenser is disposed in a required position in a projection system.

As shown in FIG. 2, a conventional light tunnel is formed by stacking four glass plates 21, with adjacent ends bonded together by adhesive. The inside surfaces of the glass plates 21 form a rectangular tunnel 22. Light can enter and leave the rectangular tunnel 22. The glass plates 21 are further held by jigs 23 directly and disposed in a projection system.

Accordingly, the aforementioned glass plates are combined by only adhesive and thus cannot endure pressure applied thereto. Moreover, bonded portions between the glass plates are easily damaged at high temperature. The glass plates may break, shift or deform under a high temperature, thus reducing stability and performance of the condenser. Further, as directly held by the jigs thus the glass plates are easily broken, reducing the lifespan thereof.

Additionally, as the outer surfaces of the glass plates are directly held by the jigs, the glass plates are easily broken, shifted or deformed at high temperature. Also, the glass plates deform or break when the pressure applied by the jigs cannot be endured by the glass plates. Furthermore, glass plates with different sizes and profiles cannot be applied to different projection systems.

### SUMMARY

Accordingly, the invention provides a light tunnel module reducing manufacturing cost and time.

Moreover, the light tunnel module provides better stability and performance at high temperature.

Additionally, the light tunnel module protects the light tunnel thereof from shifting, deforming, and breaking.

Further, the light tunnel module can be applied to various projection systems, thereby providing sharing capability.

The light tunnel module comprises a plurality of reflectors and at least one sleeve. The reflectors are piled together to form a hollow tunnel, allowing a light to pass therethrough. The inner surfaces of the reflectors are coated with films, enabling the light entering and reflecting through it.

The profile of the reflectors is trapezoid, rectangular, regular, or irregularly polygonal. The reflectors are made of glass.

The sleeve fits on the outer surfaces of the reflectors. The outer surface of at least one of the reflectors is an abutting face, and the outer surfaces of other reflectors are non-abutting faces. Adhesive is selectively applied between the abutting face and the sleeve or between the non-abutting faces and the sleeve. The abutting face tightly abuts the sleeve. The non-abutting faces are tightly or non-tightly connected to the sleeve. One end of the sleeve and an end surface enclosed by the reflectors are positioned on a same plane.

The sleeve directly fits on the outer surfaces of the reflectors. After the sleeve fits on the outer surfaces of the reflectors, adhesive is selectable applied between the sleeve and the outer surfaces of the reflectors, positioning and fixing the sleeve and outer surfaces of the reflectors.

The sleeve is an integrally formed structure or an assembly constituted by several separate pieces. The profile of the sleeve is flared, pillared, tubular, rectangular or polygonal. The length of the sleeve is equal to or less than those of the reflectors. The sleeve fits on one end, two ends or the middle of the reflectors. The material of the sleeve is selected from the group consisting of plastic, metal, alloy, stainless steel, and ceramic.

Accordingly, being indirectly held by jigs through the sleeve, the reflectors are not easily deformed, distorted, or broken under high temperature, enhancing stability and performance of the light tunnel module.

As the sleeve fits on the outer surfaces of the reflectors, the light tunnel formed by the reflectors has a fixed size.

As the outer surfaces of the reflectors are covered by the sleeve, the inner size of the sleeve changes with the sizes of the reflectors and the outer profile of the sleeve still matches the original projection system. Namely, the sleeve can fit on different reflectors and be disposed in the same projection systems.

### DESCRIPTION OF THE DRAWINGS

The invention can be more fully understood by reading the subsequent detailed description and examples with references made to the accompanying drawings, wherein:

FIG. 1 is a schematic view of a conventional DLP of Taiwan Patent No. 517855;

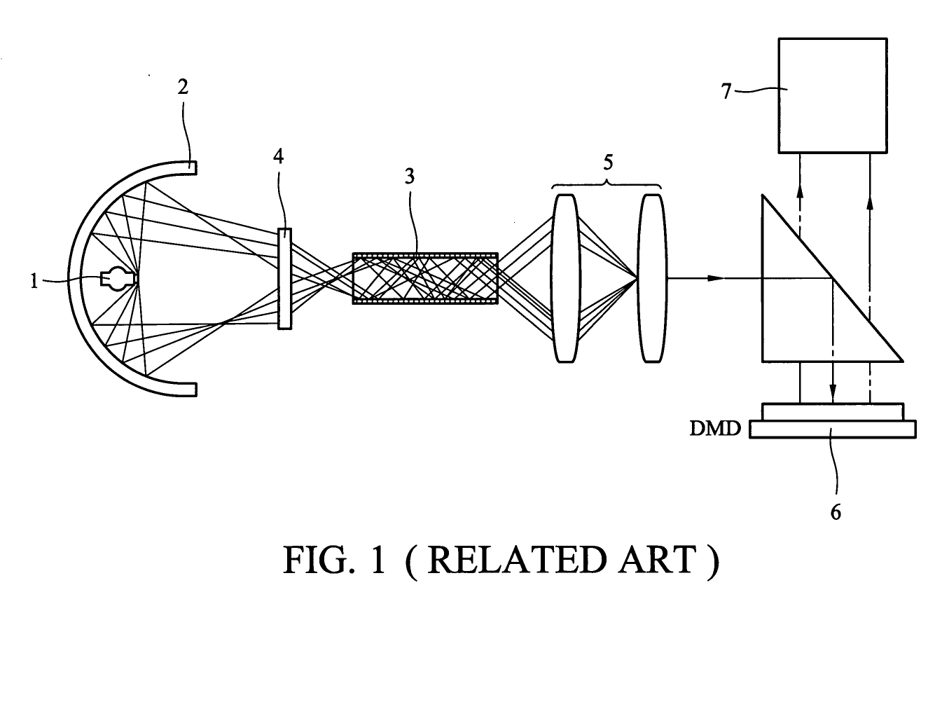

FIG. 2 is a schematic perspective view of the structure of a conventional light tunnel;

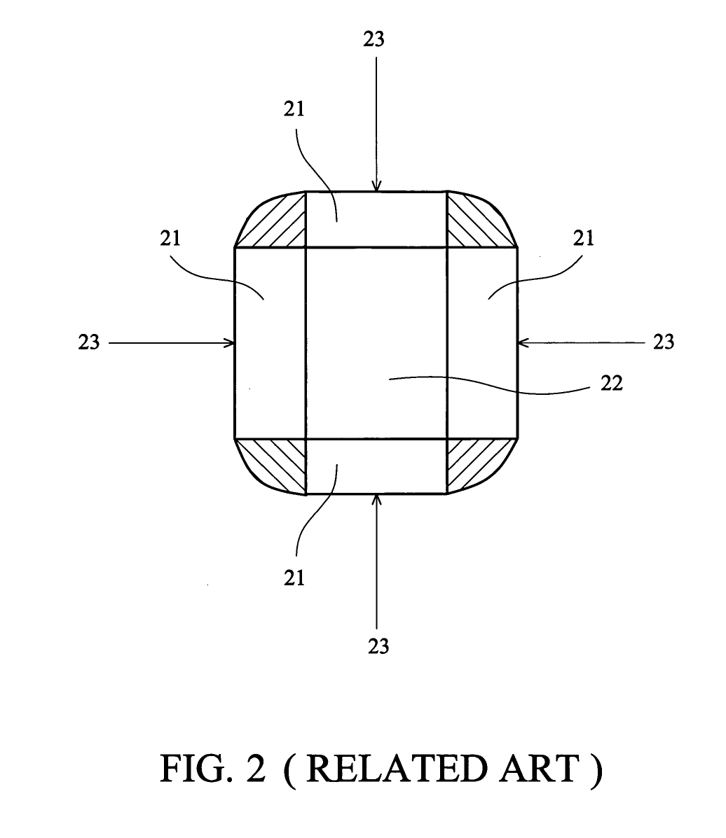

FIG. 3A is a schematic perspective view of the light tunnel module of a first embodiment of the invention;

FIG. 3B is a schematic cross section of the light tunnel module of a first embodiment of the invention;

FIG. 4A is a schematic perspective view of the light tunnel module: of a second embodiment of the invention;

FIG. 4B is a partially exploded perspective view of the light tunnel module of a second embodiment of the invention;

FIG. 5 is a schematic perspective view of the light tunnel module of a third embodiment of the invention;

FIG. 6 is a schematic cross section of the light tunnel module of a fourth embodiment of the invention;

FIG. 7 is a schematic cross section of the light tunnel module of a fifth embodiment of the invention; and

FIG. 8 is a schematic cross section of the light tunnel module of a sixth embodiment of the invention.

### DETAILED DESCRIPTION

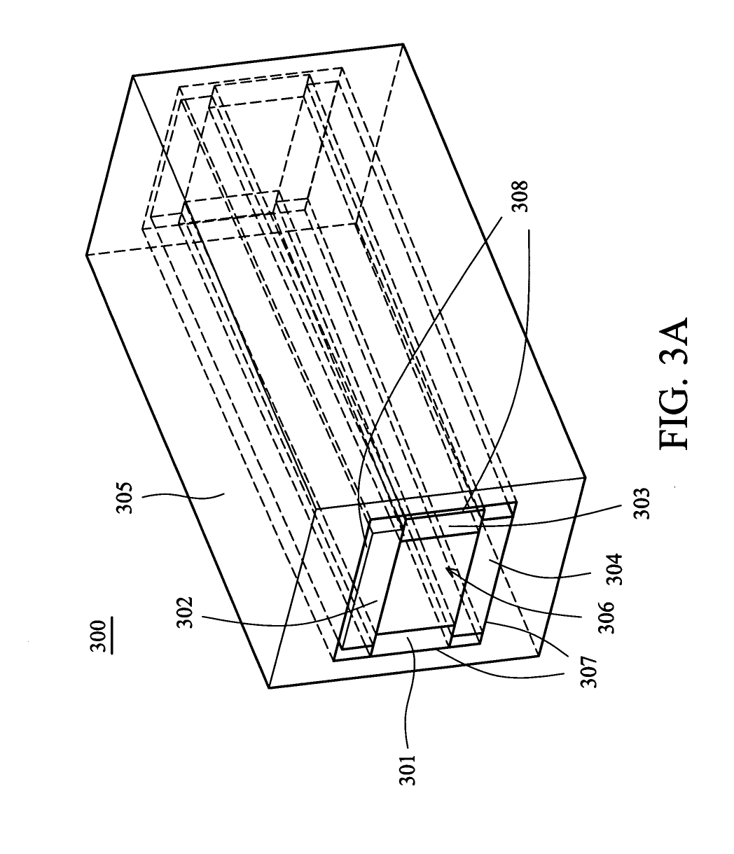

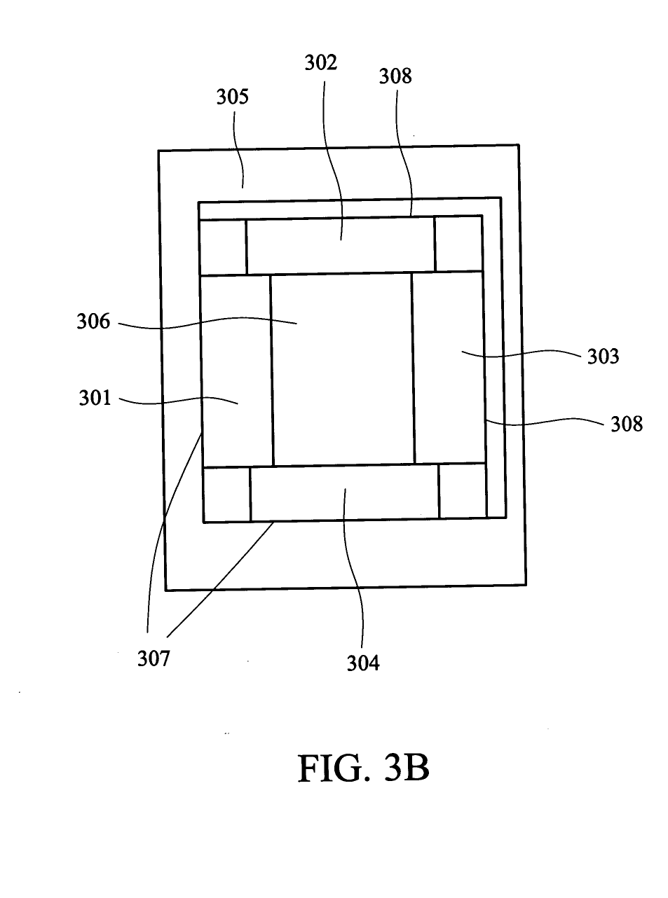

FIG. 3A is a schematic perspective view of the light tunnel module 300 of a first embodiment of the invention. FIG. 3B is a schematic cross section of FIG. 3A. The light tunnel module 300 comprises a first reflector 301, a second reflector 302, a third reflector 303, a fourth reflector 304 and a sleeve 305. The first reflector 301, the second reflector 302, the third reflector 303 and the fourth reflector 304 are piled together, forming a rectangular hollow tunnel, i.e. light tunnel 306, surrounded by the inner surfaces thereof. The first reflector 301, the second reflector 302, the third reflector 303 and the fourth reflector 304 are made of glass. The inner surfaces of the first reflector 301, the second reflector 302, the third reflector 303 and the fourth reflector 304 are coated with films, enabling reflection of a light thereon. The sleeve 305 fits on the outer surfaces of the first reflector 301, the second reflector 302, the third reflector 303 and the fourth reflector 304.

As shown in FIG. 3A and FIG. 3B, the first reflector 301, the second reflector 302, the third reflector 303 and the fourth reflector 304 are fixed by overlapping and bonding parts thereof. The first reflector 301 and the third reflector 303 are trapezoid and of the same size. The second reflector 302 and the fourth reflector 304 are rectangular and of the same size. The first reflector 301, the second reflector 302, the third reflector 303 and the fourth reflector 304 have the same length. Part of the inside surface of the second reflector 302 is bonded to one side of the first reflector 301 and the third reflector 303. Bonded portions between the second reflector 302 and the first reflector 301 are straight, so as that between the second reflector 302 and the third reflector 303. The length of the bonded portions equals to that of the second reflector 302. The fourth reflector 304 is bonded to one side of the first reflector 301 and the third reflector 303 is in the same manner as the second reflector 302 is.

Additionally, the outer surfaces of the first reflector 301 and the fourth reflector 304 serve as abutting faces 307. The sleeve 305 tightly abuts the abutting faces 307. The outer surfaces of the second reflector 302 and the third reflector 303 serve as non-abutting faces 308. After the sleeve 305 fits on the outer surfaces of the reflector 301 and the reflector 304, adhesive is applied between the sleeve 305, the outer surfaces of the reflector 302 and the reflector 303. Thus the non-abutting faces 308 are indirectly connected to the sleeve by adhesive. As shown in FIG. 3A, one end of the sleeve 305 and an end surface enclosed by the first reflector 301, the second reflector 302, the third reflector 303 and the fourth reflector 304 are positioned on a same plane. In this embodiment, the length of the sleeve 305 is equal to those of the first reflector 301, the second reflector 302, the third reflector 303 and the fourth reflector 304.

Accordingly, positioning or fixing of the sleeve 305, the first reflector 301, the second reflector 302, the third reflector 303 and the fourth reflector 304 is complete. As fusing at a high-temperature is not required during the fitting process of the sleeve 305, the material of the sleeve 305 can be selected from the group consisting of plastic, metal, alloy, stainless steel, ceramic or other inexpensive and easily processed material.

Being indirectly held by jigs through the sleeve 305, the first reflector 301, the second reflector 302, the third, reflector 303, and the fourth reflector 304 are not easily deformed, distorted, or broken by the jigs under high temperature, thereby enhancing stability and performance of the light tunnel 306.

Moreover, the light tunnel module of the invention is not limited to the aforementioned structure.

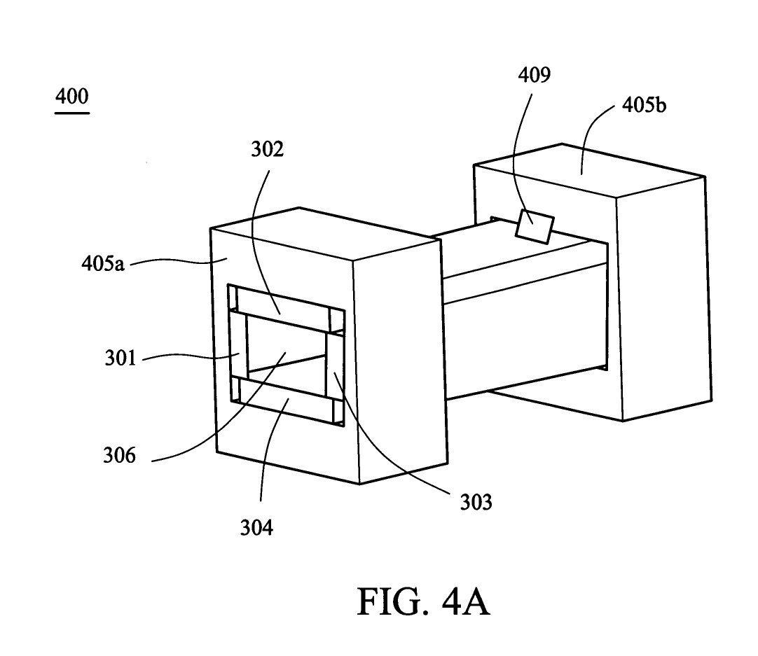

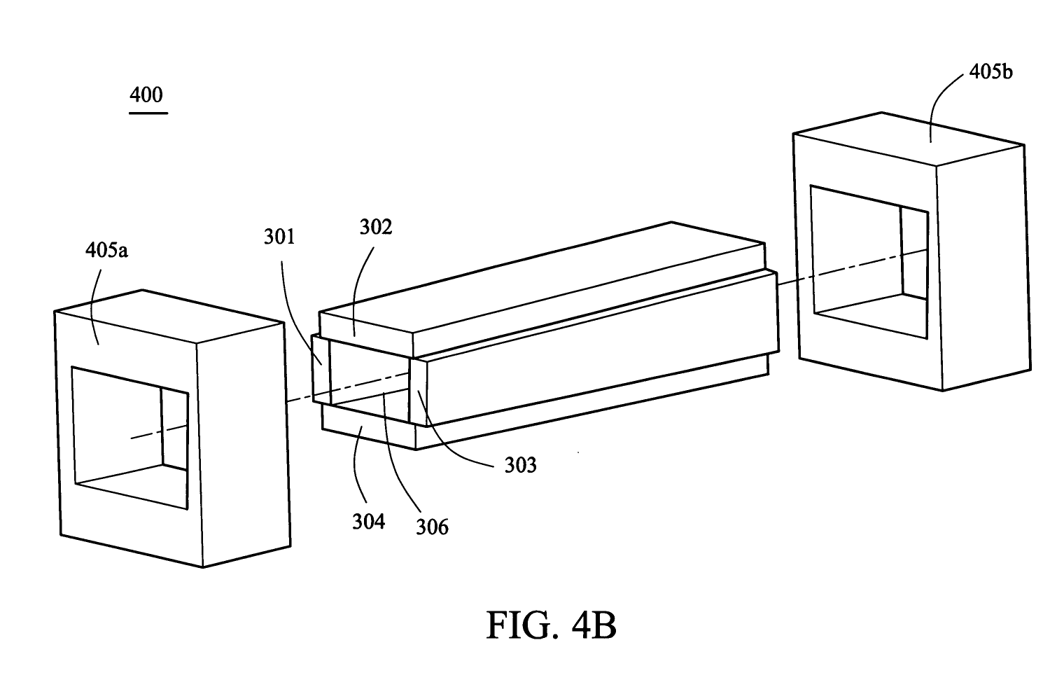

FIG. 4A is a schematic perspective view of the light tunnel module 400 of a second embodiment of the invention. FIG. 4B is a partially exploded perspective view of the light tunnel module 400 of the second embodiment of the invention. Elements corresponding to those in the first embodiment share the same reference numerals. As shown in FIG. 4B, the difference between the light tunnel modules 400 and 300 is that the light tunnel module 400 comprises two sleeves 405a and 405b. The sleeves 405a and 405b fit on two ends of the first reflector 301, the second reflector 302, the third reflector 303 and the fourth reflector 304, respectively. The length of the sleeves 405a and 405b is less than those of the first reflector 301, the second reflector 302, the third reflector 303 and the fourth reflector 304. The two ends of the first reflector 301, the second reflector 302, the third reflector 303 and the fourth reflector 304 are respectively covered by the sleeves 405a and 405b.

In this embodiment, the inner sizes of the sleeves 405a and 405b correspond to those of the outer surfaces of the first reflector 301, the second reflector 302, the third reflector 303 and the fourth reflector 304. The first reflector. 301 and the third reflector 303 are trapezoid and of the same size. After the first reflector 301, the second reflector 302, the third reflector 303 and the fourth reflector 304 are stacked, the sleeve 405b first fits thereon and is positioned on one end thereof. The sleeve 405a then fits on the first reflector 301, the second reflector 302, the third reflector 303 and the fourth reflector 304 and is positioned on the narrower end thereof. The sleeve 405b is bonded to the outer surface of the second reflector 302 by adhesive applied to a bonding portion 409 shown in FIG. 4A, such that bonding therebetween is enhanced.

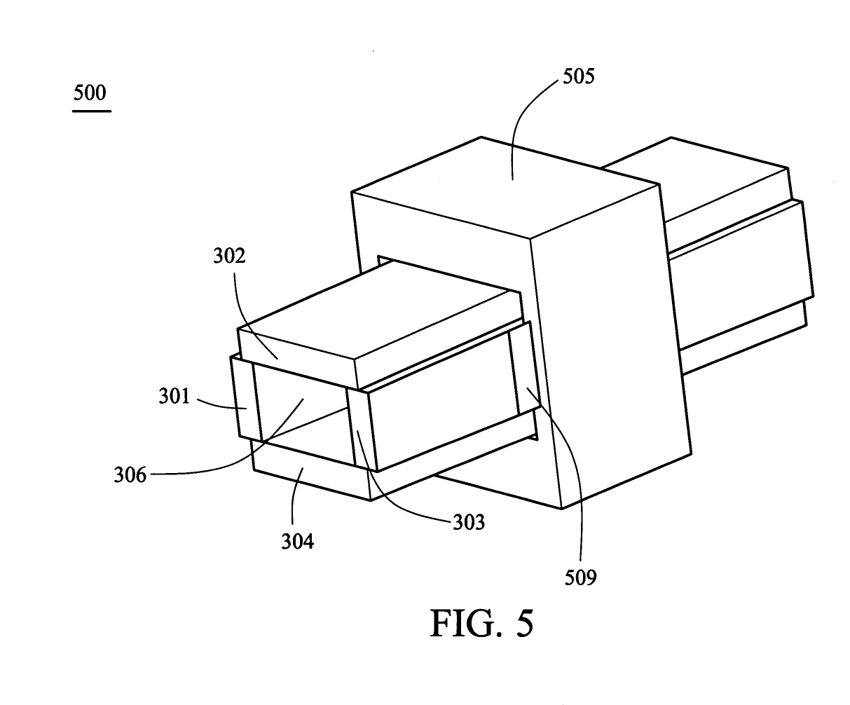

FIG. 5 is a schematic perspective view of the light tunnel module 500 of a third embodiment of the invention. Elements corresponding to those in the first embodiment share the same reference numerals. The difference between the light tunnel modules 500 and 300 is that the light tunnel module 500 comprises a sleeve 505 fitting on the middle of the first reflector 301, the second reflector 302, the third reflector 303 and the fourth reflector 304. The inner size of the sleeve 505 corresponds to the size of the middle of the outer surfaces of the first reflector 301, the second reflector 302, the third reflector 303 and the fourth reflector 304. Structure, disposition, and function of other elements of this embodiment are the same as those in the first embodiment, and explanation thereof is omitted for simplicity. Specifically, the sleeve 505 fits on the middle of the first reflector 301, the second reflector 302 the third-reflector 303 and the fourth reflector 304 after the first reflector 301, the second reflector 302, the third reflector 303 and the fourth reflector 304 are piled together and positioned. The sleeve 505 is bonded to the outer surface of the third reflector 303 by adhesive applied to a bonding portion 509 shown in FIG. 5.

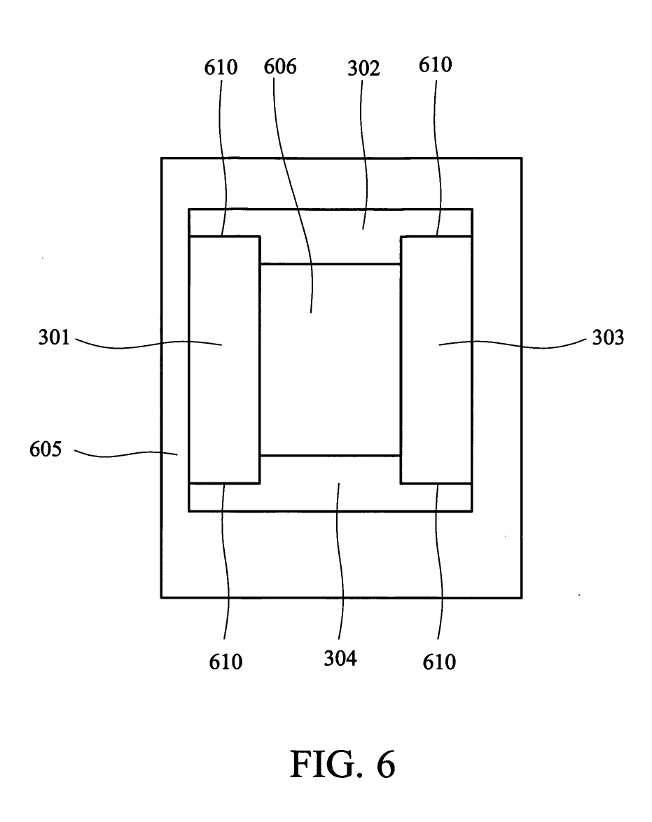

FIG. 6 is a schematic cross section of the light tunnel module of a fourth embodiment of the invention. Elements corresponding to those in the first embodiment share the same reference numerals. The difference between this embodiment and the first embodiment is that both the second reflector 302 and the fourth reflector 304 simultaneously comprise a ladder-shaped cross section and a recessed groove 610, and both the first reflector 301 and the third reflector 303 comprise a rectangular cross section. Specifically, two ends of the first reflector 301 and the third reflector 303 are tightly received in the recessed grooves 610 of the second reflector 302 and the fourth reflector 304, forming a rectangular light tunnel 606. Structure, disposition, and function of other elements of this embodiment are the same as those in the first embodiment, and explanation thereof is omitted for simplicity. At least one sleeve 605 then fits on the first reflector 301, the second reflector 302, the third reflector 303 and the fourth reflector 304.

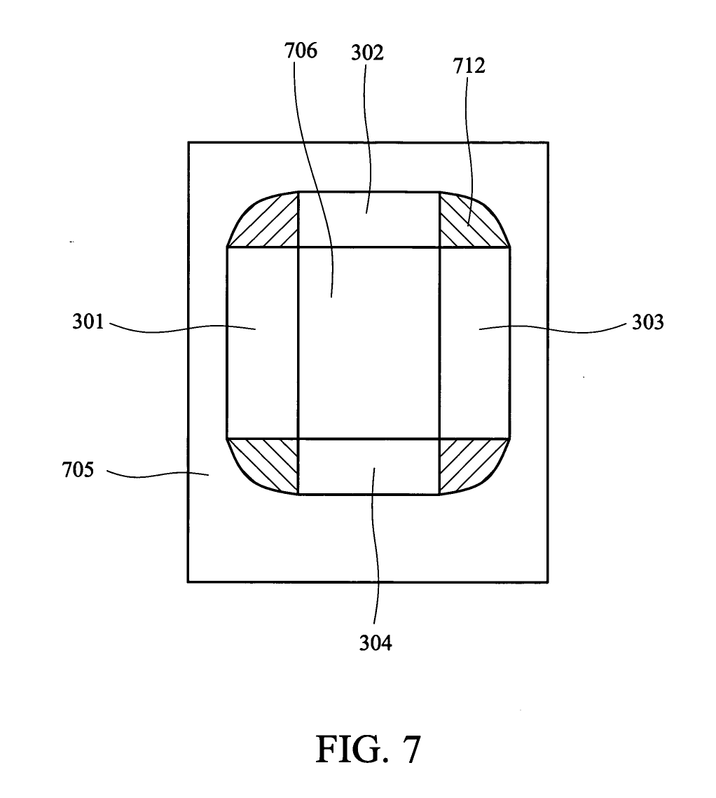

FIG. 7 is a schematic cross section of the light tunnel module of a fifth embodiment of the invention. Elements corresponding to those in the first embodiment share the same reference numerals. The difference between this embodiment and the first embodiment is that the first reflector 301, the second reflector 302, the, third reflector 303 and the fourth reflector 304 are sequentially bonded to each other by adhesive applied in end portions 712 adjacent thereto. A rectangular light tunnel 706 is thereby formed. Structure, disposition, and function of other elements of this embodiment are the same as those in the first embodiment, and explanation thereof is omitted for simplicity. At least one sleeve 705 then fits on the first reflector 301, the second reflector 302, the third reflector 303 and the fourth reflector 304.

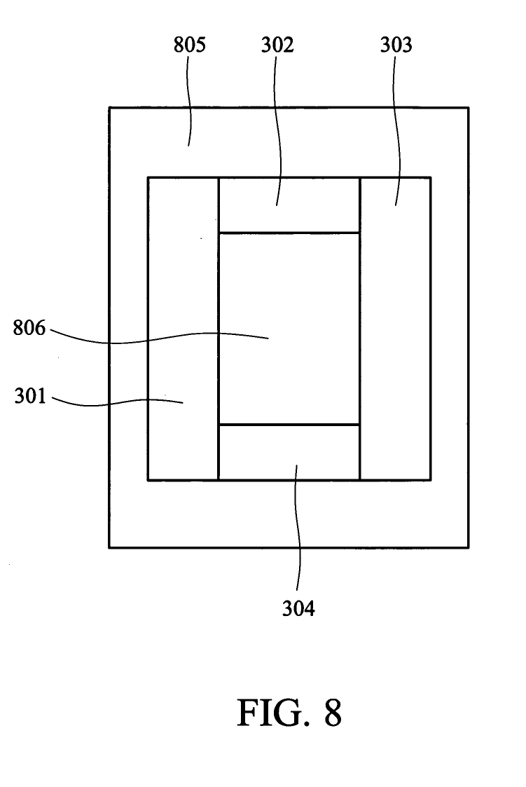

FIG. 8 is a schematic cross section of the light tunnel module of a sixth embodiment of the invention. Elements corresponding to those in the first embodiment share the same reference numerals. The difference between this embodiment and the first embodiment is that two margins of the second reflector 302 and the fourth reflector 304 are attached to part of the inside surfaces of the first reflector 301 and the third reflector 303. A light tunnel 806 is thereby formed. Structure, disposition, and function of other elements of this embodiment are the same as those in the first embodiment, and explanation thereof is omitted for simplicity. Similarly, at least one sleeve 805 then fits on the first reflector 301, the second reflector 302, the third reflector 303 and the fourth reflector 304.

Accordingly, as the aforementioned sleeves fit on and are fixed to the outer surfaces of the first, the second, the third and the fourth reflectors, light tunnels formed by the first, the second, the third and the fourth reflectors can be of fixed sizes.

Moreover, as the outer surfaces of the first, second, third, and fourth reflectors are covered by the sleeves, the inner sizes of the sleeves can be changed to match the outer surfaces of the first, the second, the third and the fourth reflectors while the outer profiles of the sleeves are fixed. Thus, the sleeves can be applied to the same projection system even though fitting on different sizes of the first, the second, the third and the fourth reflectors.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A light tunnel module, comprising:
a plurality of reflectors; and
at least one sleeve for completely or partially covering the reflectors, wherein the reflectors are piled together to form a hollow tunnel, allowing a light to pass therethrough.

2. The light tunnel module as claimed in claim 1, wherein inner surfaces of the reflectors are coated with films.

3. The light tunnel module as claimed in claim 1, wherein the profile of the reflectors is trapezoid, rectangular or polygonal.

4. The light tunnel module as claimed in claim. 1, wherein the reflectors are made of glass.

5. The light tunnel module as claimed in claim 1, wherein the sleeve fits on one end, two ends, or the middle of outer surfaces of the reflectors.

6. The light tunnel module as claimed in claim 1, wherein the outer surface of at least one of the reflectors serves as an abutting face tightly abutting the sleeve, and the outer surfaces of the other reflectors are non-abutting faces.

7. The light tunnel module as claimed in claim 6, wherein the non-abutting faces are indirectly connected to the sleeve by adhesive.

8. The light tunnel module as claimed in claim 6, wherein the non-abutting faces are tightly or non-tightly connected to the sleeve.

9. The light tunnel module as claimed in claim 1, wherein one end of the sleeve and an end surface enclosed by the reflectors are positioned on a same plane.

10. The light tunnel module as claimed in claim 1, wherein, after the sleeve fits on outer surfaces of the reflectors, adhesive is applied between the sleeve and the outer surfaces of the reflectors.

11. The light tunnel module as claimed in claim 1, wherein the sleeve is an integrally formed structure or an assembly constituted by several separate pieces.

12. The light tunnel module as claimed in claim 1, wherein the profile of the sleeve is flared, pillared, tubular, rectangular or polygonal.

13. The light tunnel module as claimed in claim 1 wherein the length of the sleeve is equal to or less than those of the reflectors.

14. The light tunnel module as claimed in claim 1, wherein the material of the sleeve is selected from the group consisting of plastic, metal, alloy, stainless steel and ceramic.

15. The light tunnel module as claimed in claim 1, wherein the reflectors are stacked by overlapping and bonding parts thereof.

16. The light tunnel module as claimed in claim 1, wherein the reflectors comprise a ladder-shaped cross section and recessed grooves while the reflectors are piled together through the recessed grooves.

17. The light tunnel module as claimed in claim 1, wherein the reflectors are stacked by bonding adjacent ends thereof with adhesive.

18. The light tunnel module as claimed in claim 1, wherein the reflectors are stacked by attaching two sides of one reflector to inside surfaces of other adjacent reflectors.
